(19) United States
(12) Patent Application Publication
(10) Pub. No.: US 2008/0202347 A1
(43) Pub. Date: Aug. 28, 2008

(54) Actuating Mechanism of an Automatic Toaster

(75) Inventors: Huajin Chen, Shenzhen (CN); Youying Long, Shenzhen (CN)

Correspondence Address: HAMRE, SCHUMANN, MUELLER & LARSON, P.C., P.O. BOX 2902, MINNEAPOLIS, MN, 55402-0902, US

(73) Assignee: CRASTAL TECHNOLOGY (SHENZHEN CO., LTD), Shenzhen (CN)

(21) Appl. No.: 10/592,215

(22) PCT Filed: Jan. 4, 2005
(86) PCT No.: PCT/CN2005/000014

§ 371 Date: Jan. 23, 2008

(30) Foreign Application Priority Data
Mar. 11, 2004 (CN) 200420043629.6

(51) Int. Cl. A47J 37/08; A21B 3/00

(52) U.S. Cl. 99/326; 99/393

(57) ABSTRACT

The present invention relates to a toaster, in particular to a recognition device of the toaster. A sliding rack which can be moved up and down is provided within a housing of the toaster, and the sliding rack is connected with a toast rack. An end of the toast rack is fixedly connected to an end of a bracket, an assembly composed of the toast rack and the bracket is hinged to the sliding rack, an end portion of the bracket is connected with the sliding rack through a spring, and a sensor is fixed to the toaster for sensing the angular displacement of the assembly. One end of the bracket is hinged to the sliding rack and the other end thereof is connected with the sliding rack through the spring. Compared with the prior art, the toast rack of the present invention can be driven to rotate upwards at a certain angle about a center defined by the hinged point under the resilient force of a spring. When a bread slice is disposed into the toast rack, the toast rack is reset. The sensor can obtain a signal indicating the reset of the toast rack and transmit the signal to a control chip to control the automatic actuating mechanism of the toaster. The toaster of the present invention is simple in structure and safe in use, and is of low cost.

### TECHNICAL FIELD OF THE INVENTION

The present invention relates to a toaster, particularly, to an actuating mechanism of an automatic toaster.

### BACKGROUND OF THE INVENTION

A commercially available toaster generally comprises a housing, a handle, a base, an electronic timer and a core. The conventional toaster mainly functions to toast in timing, which is used to make a regular bread slice toasted brown. Users can regulate a toasting time as desired.

The conventional toaster can be operated in the following manner. A bread slice is disposed into a slot of a toast rack and supported by a sliding rack connected to a handle and the toast rack connected to the sliding rack. A toasting time is set by an electronic timer. After the handle is manually pressed to move the sliding rack and the toast rack, which carries the bread, downwards to the bottom of the slot. At this time, a circuit is turned on through a switch, and windings of the electronic timer are powered on to render a ferrous piece to be attracted. The handle, the sliding rack and the toast rack are retained in their original positions, and heaters are powered on to toast the bread. After the bread is toasted for a predetermined time set by the electronic timer, the windings of the electronic timer are powered-off, the ferrous piece is thereby released. As a result, the sliding rack, the handle and the toast rack are driven together with the bread to move upward to their normal positions under a pulling force of a spring.

However, the structure of the conventional toaster has some disadvantages. For example, if the resilient force executed by the spring of the toast rack is too strong, a relatively small bread slice will be flicked up into air; and, if the resilient force executed by the spring is too weak, a relatively large bread slice will fail to be elevated to its normal position, or, a small bread slice will fail to be elevated high enough to take the toasted bread out. Consequently, an automatic toaster has been provided, in which a motor is employed to drive a sliding rack to move up and down. However, the motor in this structure needs to be activated manually.

### SUMMARY OF THE INVENTION

An object of the present invention is to provide an actuating mechanism of an automatic toaster, with which the toaster can be actuated automatically when a bread slice is disposed in a toast rack of the toaster.

Therefore, the present invention provides an actuating mechanism of an automatic toaster, which comprises a sliding rack movable up and down positioned within a housing of the toaster. The sliding rack is connected to a toast rack. An end of the toast rack is fixedly connected to an end of a bracket, and an assembly composed of the toast rack and the bracket is hinged to the sliding rack. An end portion of the bracket is connected with the sliding rack through a spring. A sensor is fixed in the toaster for sensing the angular displacement of the assembly.

According to the present invention, one end of the bracket is hinged to the sliding rack and the other end thereof is connected with the sliding rack through the spring.

According to the present invention, a lower portion of the bracket is hinged to the sliding rack, the spring is located above a hinged point at which the bracket is hinged to the sliding rack, and the spring is a tension spring.

According to the present invention, a joint portion at which the toast rack is connected with the bracket is hinged to the sliding rack, and a free end of the bracket is connected with the sliding rack through the spring.

According to the present invention, the sensor is fixed at a rear supporting board of a toaster frame.

According to the present invention, the sensor is fixed at a front supporting board of the toaster frame.

According to the present invention, an end of a fixed toast rack is connected to the sliding rack.

According to the present invention, a joint portion at which the toast rack is connected to the bracket is hinged to the fixed toast rack, and the end portion of the bracket is connected with the sliding rack through the spring.

According to the present invention, a joint portion at which the toast rack is connected to the bracket is hinged to the fixed toast rack, and the end portion of the bracket is connected with the fixed toast rack through the spring.

According to the present invention, a joint portion at which the toast rack is connected to the bracket is hinged to a core bracket disposed at a bottom board of the toaster frame, and the end portion of the bracket is connected with the core bracket through the tension spring.

According to the present invention, a joint portion at which the toast rack is connected to the bracket is hinged to a rear supporting board of the toaster frame, and the end portion of the bracket is connected with the rear supporting board through the tension spring.

According to the present invention, the sensor comprises an infrared light emitting diode and an infrared sensitive diode which are arranged opposite to each other.

According to the present invention, the sensor comprises a pressure-controlled switch.

According to the present invention, the sensor comprises a magnetic reed switch and a little piece of magnet which are arranged opposite to each other.

Compared to the prior art, the toast rack of the present invention can be driven to rotate upwards to a certain angle about a center defined by the hinged point under the resilient force of a spring. When a bread slice is disposed into the toast rack, the toast rack is reset. The sensor can obtain a signal indicating the reset of the toast rack and transmit the signal to a control chip to control the toaster to be automatically initiated. The toaster of the present invention is simple in structure and safe in use, and is of a low cost.

### BRIEF DESCRIPTION OF THE DRAWINGS

FIG. 1 is a front view of a first embodiment of the present invention;

FIG. 2 is a left view of FIG. 1;

FIG. 3 a schematic view showing that a bread slice is disposed on the toast rack in FIG. 2;

FIG. 4 is a top view of FIG. 1;

FIG. 5 is a front view of a second embodiment of the present invention;

FIG. 6 is a left view of FIG. 5;

FIG. 7 a schematic view showing that bread is disposed on the toast rack in FIG. 6;

FIG. 8 is a top view of FIG. 5;

FIG. 9 is a front view of a third embodiment of the present invention;

FIG. 10 is a left view of FIG. 9;

FIG. 11 a schematic view showing that bread is disposed on the toast rack in FIG. 10;

FIG. 12 is a top view of FIG. 9;

FIG. 13 is a schematic view showing that no bread is disposed on the toast rack in a fourth embodiment of the present invention;

FIG. 14 is a schematic view showing that bread is disposed on the toast rack in FIG. 13;

FIG. 15 is a front view of a fifth embodiment of the present invention;

FIG. 16 is a left view of FIG. 15;

FIG. 17 a schematic view showing that bread is disposed on the toast rack in FIG. 16;

FIG. 18 is a top view of FIG. 15;

FIG. 19 is a schematic view showing that no bread is disposed on the toast rack in a sixth embodiment of the present invention;

FIG. 20 is a schematic view showing that bread is disposed on the toast rack in FIG. 19;

FIG. 21 is a schematic view showing that no bread is disposed on the toast rack in a seventh embodiment of the present invention;

FIG. 22 is a schematic view showing that bread is disposed on the toast rack in FIG. 21;

FIG. 23 is a top view of FIG. 21;

FIG. 24 is a schematic view showing that no bread is disposed on the toast rack in an eighth embodiment of the present invention;

FIG. 25 is a schematic view showing that bread is disposed on the toast rack in FIG. 24;

FIG. 26 is a schematic view showing that no bread is disposed on the toast rack in a ninth embodiment of the present invention;

FIG. 27 is a schematic view showing that bread is disposed on the toast rack in FIG. 26;

FIG. 28 is a schematic view showing that no bread is disposed on the toast rack in a tenth embodiment of the present invention;

FIG. 29 is a schematic view showing that bread is disposed on the toast rack in FIG. 28;

FIG. 30 is a schematic view showing that no bread is disposed on the toast rack in an eleventh embodiment of the present invention;

FIG. 31 is a schematic view showing that bread is disposed on the toast rack in FIG. 30; and

FIG. 32 is a schematic view of an electrical circuit according to embodiments of the present invention.

### DETAILED DESCRIPTION OF THE INVENTION

The present invention and various advantages thereof will be described with reference to exemplary embodiments in conjunction with the drawings.

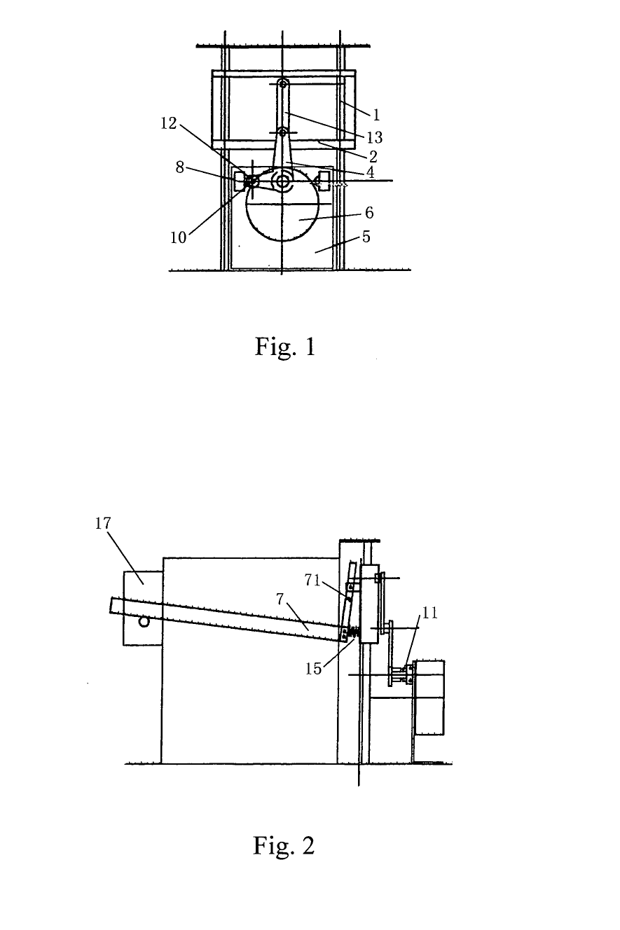

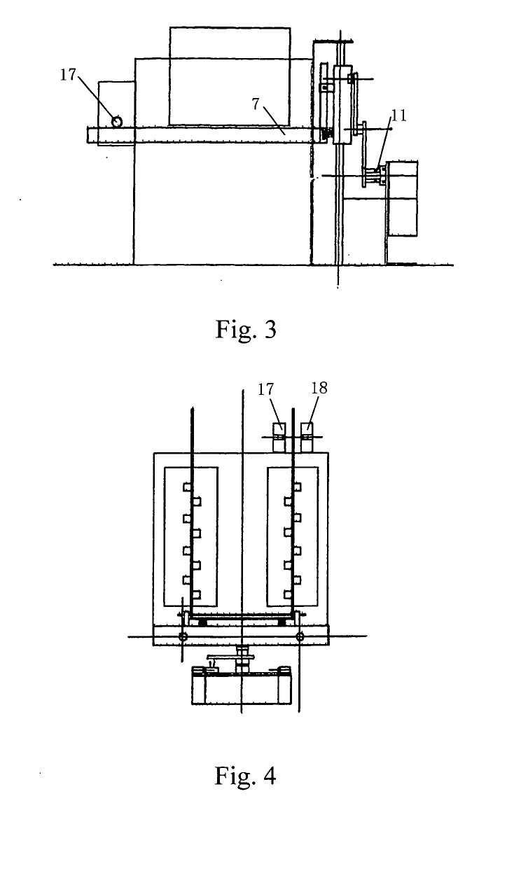

As shown in FIGS. 1, 2, 3 and 4, provided is an actuating mechanism of an automatic toaster according to the present invention which includes a housing, a toaster frame 5, a sliding rack 2, a timer controlled by a CPU, and a core portion.

In the toaster, vertical guide rails 1 are fixed at the toaster frame 5. The sliding rack 2 is slidably coupled to the vertical guide rails 1 so that the sliding rack 2 can be moved up and down along the vertical guide rails 1. A toast rack 7 is provided for supporting bread disposed thereon. A bracket 71, which is disposed longitudinally, is fixedly connected to an end of the toast rack 7. An upper end of the bracket 71 is hinged to the sliding rack 2 and a lower end thereof is connected with the sliding rack 2 through a compressive spring 15. In the vicinity of a free end of the toast rack 7, an infrared light emitting diode 17 and an infrared sensitive diode 18 are oppositely arranged at a rear supporting board of the toaster frame. Alternatively, the infrared light emitting diode 17 and the infrared sensitive diode 18 can be arranged at a front supporting board of the toaster frame. In addition, a magnetic reed switch and a little piece of magnet can be adapted to replace the infrared light emitting diode 17 and the infrared sensitive diode 18, respectively.

A motor 6 is mounted on a side wall of a fixed board of the toaster frame 5. The motor 6 may be embodied by a low-speed permanent-magnet synchronous non-directional motor. An output shaft 11 of the motor 6 is connected to an end of a crank 4, which forms a crank-rocker mechanism for driving the sliding rack 2 to move up and down.

An upper limit switch 8 is mounted at a left side of the fixed board and a lower limit switch 9 is mounted at a right side thereof. The output shaft 11 of the motor 6 is connected to one end of a contact 10 and a trolley wheel 12 is provided at the other end thereof. The contact 10 and one end of the crank 4 can be integrally configured as a whole. The crank 4 is hinged to a rocker 13 that is hinged to the sliding rack 2. The upper limit switch 8 or the lower limit switch 9 may a conventional switch or a stroke switch.

When no bread is disposed in a toaster slot of the toast rack 7, the free end of the toast rack 7 is driven to rotate upwards to a certain angle about a center defined by a hinged point thereof under the resilient force of the compressive spring 15. At this time, a transmission-reception light path constructed by the infrared light emitting diode 17 and the infrared sensitive diode 18 is positioned below the free end of the toast rack 7. When a bread slice is disposed into the toaster slot of the toast rack 7, the free end of the toast rack 7 can be moved downwards under the gravity of the bread slice. Consequently, the transmission-reception light path constructed by the infrared light emitting diode 17 and the infrared sensitive diode 18 is positioned above the free end of the toast rack 7. A signal is then generated when the free end of the toast rack 7 is moved downwards and blocks the infrared passing along the light path, and the signal is transmitted to the CPU of a control circuit, as shown in FIG. 32. The CPU determines that the toast rack 7 has been moved and thereby controls the motor 6 to rotate.

The crank 4 and the contact 10 mounted to the output shaft of the motor 6 are driven to rotate for 360 degrees by the rotation of the output shaft. The sliding rack 2 can be moved downwards under a pulling force of the crank 4 and the rocker 13 mounted to the output shaft of the motor. When the sliding rack 2 reaches a lower limit position, the contact 10 exactly arrives to the position of the lower switch 9. The trolley wheel 12 at the contact 10 contacts the lower switch 9 making it turned off. At this time, upon receiving a signal indicating that the lower switch 9 is turned off, the CPU controls a relay J1 of the motor to make it turned off and, accordingly, the motor stops rotating. Then, the CPU controls an ANTI-JAM relay J being turned on and, accordingly, heaters are powered on to generate heat for toasting bread. At the same time, a timer is actuated by the CPU.

After the bread slice is toasted for a predetermined time, the ANTI-JAM relay J is turned off under the control of the CPU, the heaters are powered off and no heat is generated. Meanwhile, the relay J1 of the motor is turned on under the control of the CPU and, accordingly, the motor re-starts to rotate. Since the sliding rack 2 is disposed at the lowest position, regardless of the rotating direction of the output shaft of the motor, the sliding rack 2 will be driven to move upwards under the pushing force exerted by the crank 4 and the rocker 13 mounted to the output shaft of the motor. When the sliding rack 2 moves upwards to the upper limit position, the contact 10 exactly arrives to the same position as the upper limit switch 8 is located. The trolley wheel 12 of the contact 10 contacts the upper limit switch 8 to make it turned off. The sliding rack 2 and the toast rack 7 lift the bread up to the upper limit position. The relay J1 is turned off under the control of the CPU and, accordingly, the motor 6 stops rotating. At this time, the bread slice can be taken out, and the free end of the toast rack 7 tilts upwards under the resilient force of the compressive spring 15. Then, the toasting process is finished.

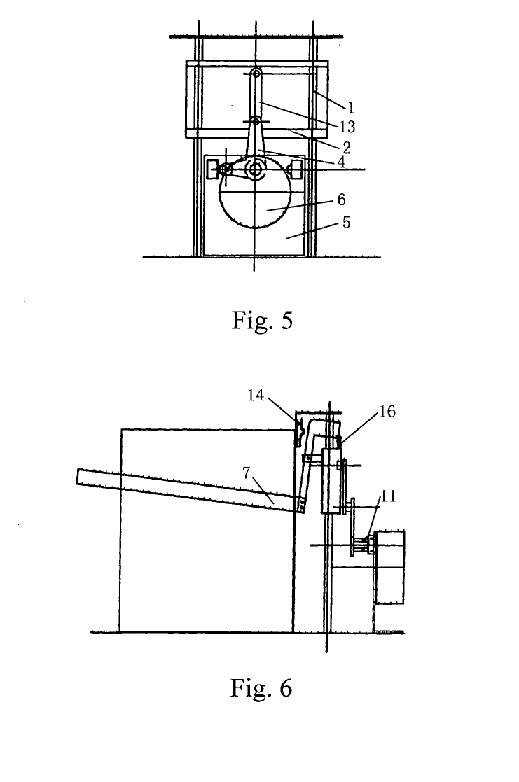

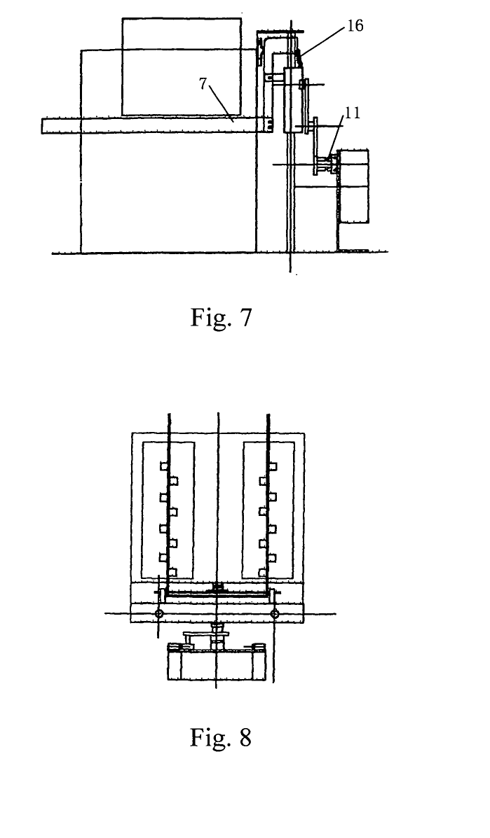

As shown in FIGS. 5, 6, 7 and 8, a middle portion or a lower end of a bracket 71 is hinged to a sliding rack 2, and an upper end thereof is connected with the sliding rack 2 through a tension spring 16. In the vicinity of the upper end of the bracket 71, a pressure-controlled switch 14 is provided at a front supporting board of a toaster frame. The free end of the toast rack 7 is driven to rotate to a certain angle about a center defined by a hinged point thereof under a resilient force of the tension spring 16. When a bread slice is disposed into a toaster slot of the toast rack 7, the free end of the toast rack 7 is moved downwards under the gravity of the bread. Subsequently, the upper end of the bracket 71 presses the pressure-controlled switch 14 and, a signal is generated indicating that the toast rack 7 has been moved.

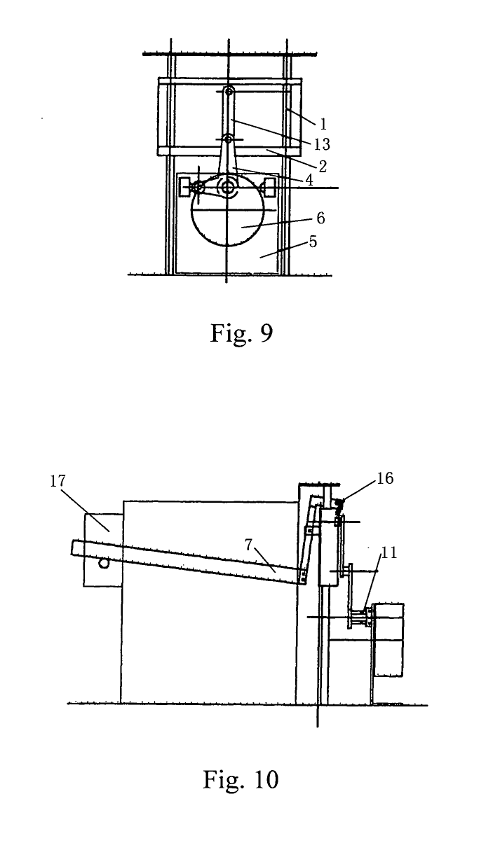

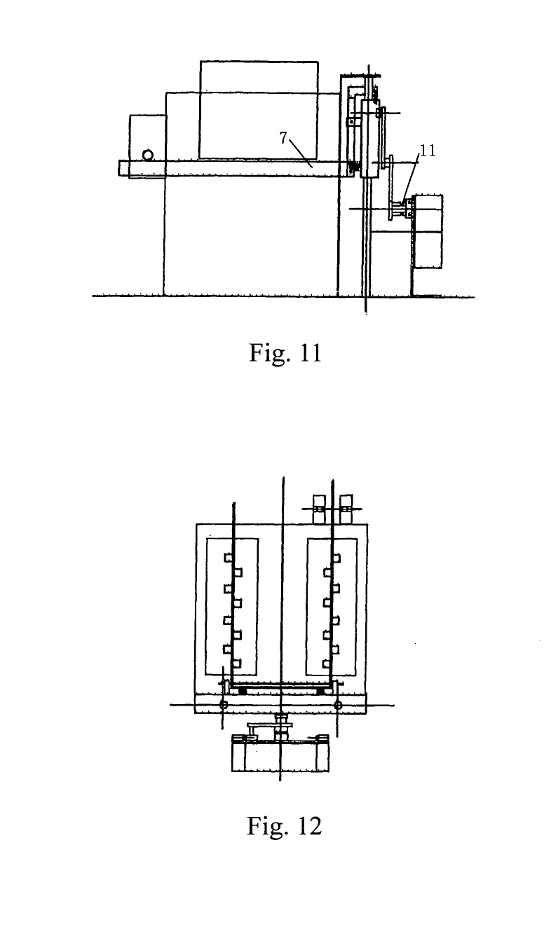

As shown in FIGS. 9, 10, 11 and 12, a middle portion of a bracket 71 is hinged to a sliding rack 2, and an upper end thereof is connected with the sliding rack 2 through a tension spring 16. In the vicinity of a free end of the toast rack 7, an infrared light emitting diode 17 and an infrared sensitive diode 18 are oppositely arranged at a rear supporting board of a toaster frame. The free end of the toast rack 7 is driven to rotate to a certain angle about a center defined by a hinged point thereof under the resilient force of the tension spring 16. When a bread slice is disposed in a toaster slot of the toast rack 7, the free end of the toast rack 7 is moved downwards under the gravity of the bread. In this case, an infrared ray passing along the light path defined by the infrared light emitting diode 17 and the infrared sensitive diode 18 is blocked by the free end of the toast rack 7 and, as a result, a signal is generated indicating that the toast rack 7 has been moved.

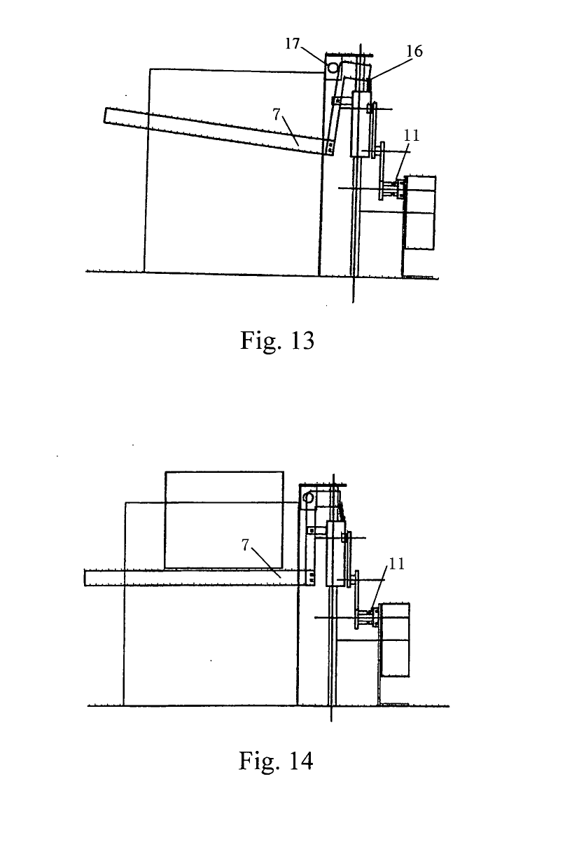

As shown in FIGS. 13 and 14, a middle portion of a bracket 71 is hinged to a sliding rack 2, and an upper end thereof is connected with the sliding rack 2 through a tension spring 16. In the vicinity of an upper end of the bracket 71, an infrared light emitting diode 17 and an infrared sensitive diode 18 are oppositely arranged on a front supporting board of a toaster frame. The free end of the toast rack 7 is driven to rotate to a certain angle about a center defined by a hinged point thereof under the resilient force of the tension spring 16. When a bread slice is disposed in a toaster slot of the toast rack 7, the free end of the toast rack 7 is moved downwards under the gravity of the bread, so that an infrared ray passing along the light path constructed by the infrared light emitting diode 17 and the infrared sensitive diode 18 is blocked by the upper end of the bracket 71 and, as a result, a signal is generated indicating that the toast rack 7 has been moved.

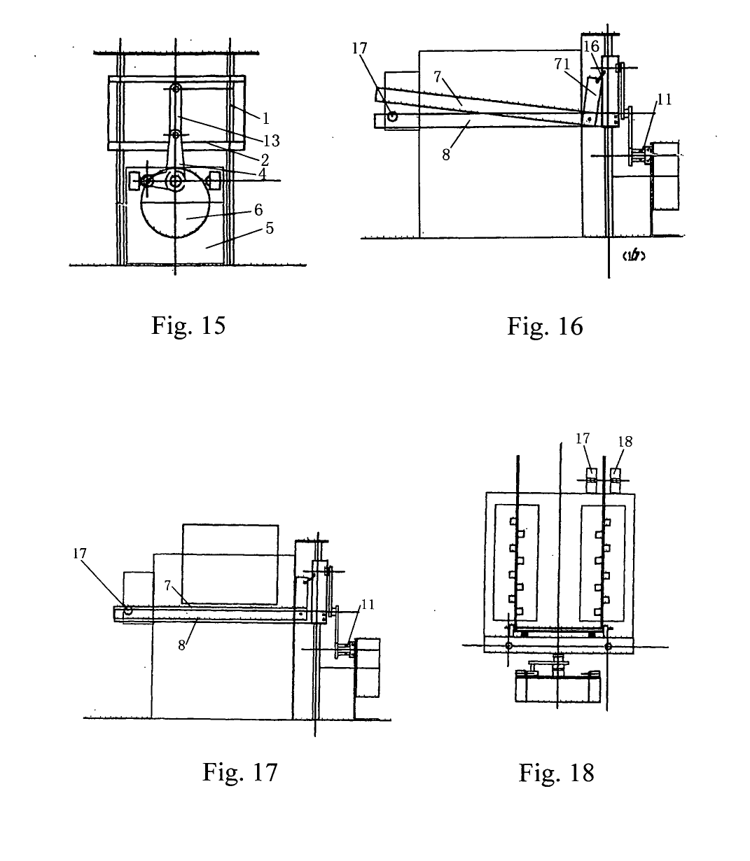

As shown in FIGS. 15, 16, 17 and 18, a fixed toast rack 8 is provided with an end thereof being connected to a sliding rack 2. The fixed toast rack 8 is hinged to a joint portion between a toast rack 7 and a bracket 71. An end of the bracket 71 is connected with the sliding rack 2 through a tension spring 16. In the vicinity of a free end of the toast rack 7, an infrared light emitting diode 17 and an infrared sensitive diode 18 are oppositely arranged at a rear supporting board of a toaster frame. The free end of the toast rack 7 is driven to rotate to a certain angle about a center defined by a hinged point thereof under a resilient force of the tension spring 16. When a bread slice is disposed in a toaster slot of the toast rack 7, the free end of the toast rack 7 is moved downwards under the gravity of the bread. As a result, an infrared ray passing along the light path constructed by the infrared light emitting diode 17 and the infrared sensitive diode 18 is blocked by the free end of the toast rack 7 and, a signal hereby is generated indicating that the toast rack 7 has been moved.

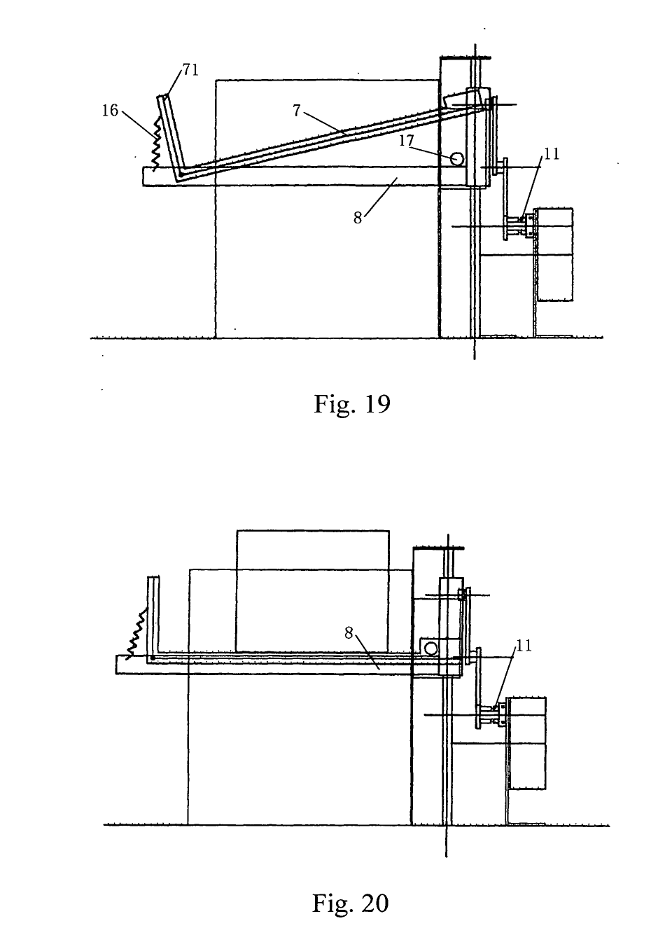

As shown in FIGS. 19 and 20, one end of the fixed toast rack 8 is connected to the sliding rack 2. A joint portion between a toast rack 7 and a bracket 71 is hinged to the fixed toast rack 8 at a position close to the other end of the fixed toast rack 8. An end of the bracket 71 is connected with the fixed toast rack 8 through a tension spring 16. In the vicinity of the sliding rack 2 and a free end of the toast rack 7, an infrared light emitting diode 17 and an infrared sensitive diode 18 are oppositely arranged at a toaster frame. The free end of the toast rack 7 is driven to rotate to a certain angle about a center defined by a hinged point thereof under the resilient force of the tension spring 16. When a bread slice is disposed into a toaster slot of the toast rack 7, the free end of the toast rack 7 is moved downwards under the gravity of the bread, which renders an infrared ray passing along the light path constructed by the infrared light emitting diode 17 and the infrared sensitive diode 18 being blocked by the free end of the toast rack 7. As a result, a signal is generated indicating that the toast rack 7 has been moved.

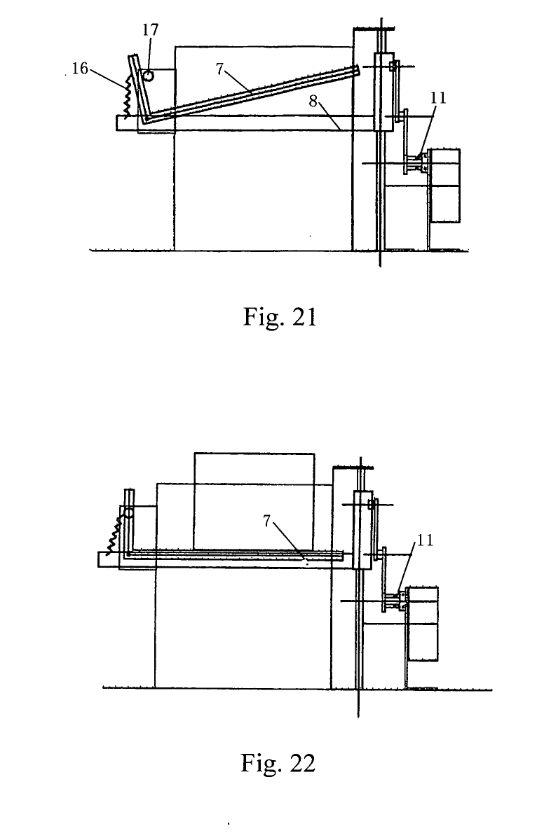

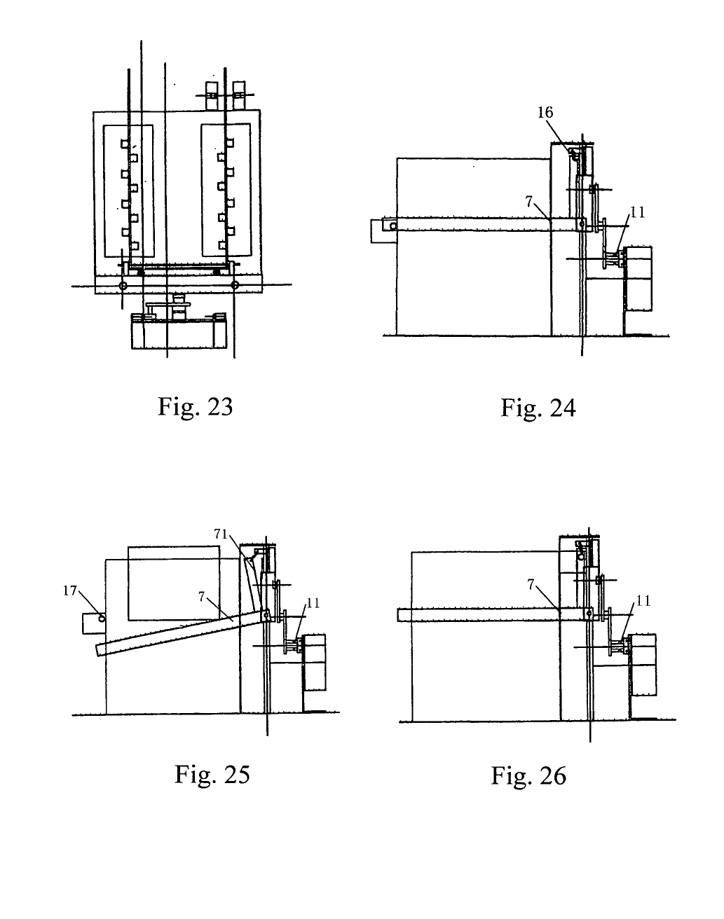

As shown in FIGS. 21, 22 and 23, one end of a fixed toast rack 8 is connected to a sliding rack 2. A joint portion between a toast rack 7 and a bracket 71 is hinged to the fixed toast rack 8 at a position close to the other end of the fixed toast rack 8. An end of the bracket 71 is connected with the fixed toast rack 8 through a tension spring 16. In the vicinity of a free end of the toast rack 7, an infrared light emitting diode 17 and an infrared sensitive diode 18 are oppositely arranged at a rear supporting board of a toaster frame. The free end of the toast rack 7 is driven to rotate to a certain angle about a center defined by a hinged point thereof under a resilient force of the tension spring 16. When a bread slice is disposed in a toaster slot of the toast rack 7, the toast rack 7 and the bracket 71 are driven to rotate to a certain angle under the gravity of the bread, and an infrared ray passing along the light path constructed by the infrared light emitting diode 17 and the infrared sensitive diode 18 is blocked by the bracket 71. A signal is hereby generated indicating that the toast rack 7 has been moved.

As shown in FIGS. 24 and 25, one end of a toast rack 7, which is connected to one end of a bracket 71, is hinged to a sliding rack 2. The other end of the bracket 71 is connected with the sliding rack 2 through a tension spring 16. In the vicinity of a free end of the toast rack 7, an infrared light emitting diode 17 and an infrared sensitive diode 18 are oppositely arranged at a rear supporting board of a toaster frame. When a bread slice is disposed into a toaster slot of the toast rack 7, the toast rack 7 and the bracket 71 rotate downwards to a certain angle under the gravity of the bread, and an infrared ray passing along the light path constructed by the infrared light emitting diode 17 and the infrared sensitive diode 18 is blocked by the toast rack 7A signal is hereby generated indicating that the toast rack 7 has been moved. When the toast rack 7 is driven to move to a bottom portion of the toaster slot by the motor 6, the toast rack 7 returns to its rest position.

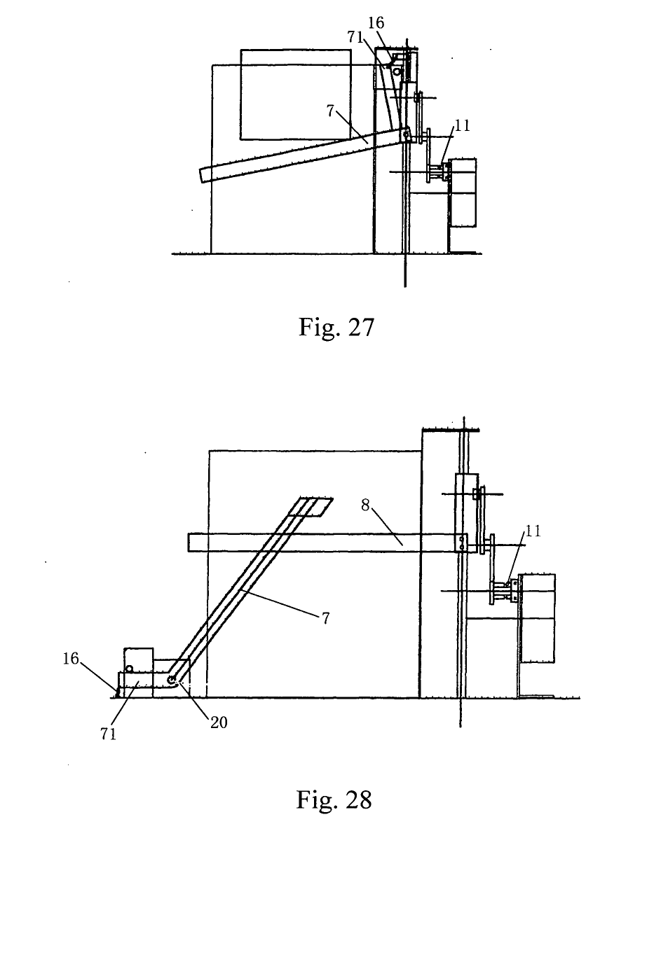

As shown in FIGS. 26 and 27, one end of a toast rack 7, which is connected to one end of a bracket 71, is hinged to a sliding rack 2. The other end of the bracket 71 is connected with the sliding rack 2 through a tension spring 16. In the vicinity of the other end of the bracket 71, an infrared light emitting diode 17 and an infrared sensitive diode 18 are oppositely arranged at a front supporting board of a toaster frame. When a bread slice is disposed into a toaster slot of the toast rack 7, the toast rack 7 and the bracket 71 are driven rotate downwards for a certain angle under the gravity of the bread, and an infrared ray passing along the light path constructed by the infrared light emitting diode 17 and the infrared sensitive diode 18 is blocked by the toast rack 7. A signal is hereby generated indicating that the toast rack 7 has been moved. When the toast rack 7 is driven to move to a bottom portion of the toaster slot by the motor 6, the toast rack 7 returns to its rest position.

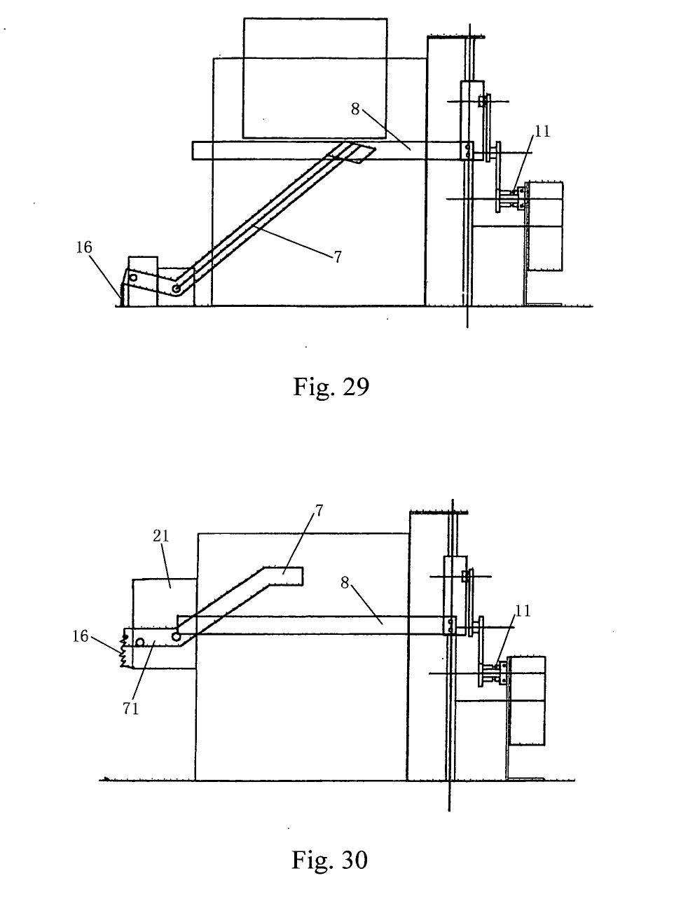

As shown in FIGS. 28 and 29, a joint portion between a toast rack 7 and a bracket 71 is hinged to a core bracket 20 disposed at a bottom board of a toaster frame. An end of the bracket 71 is connected with a core bracket 20 at the bottom board of the toaster frame through a tension spring 16. An infrared light emitting diode 17 and an infrared sensitive diode 18 are oppositely arranged at a bottom board of the core fixed to the toaster frame.

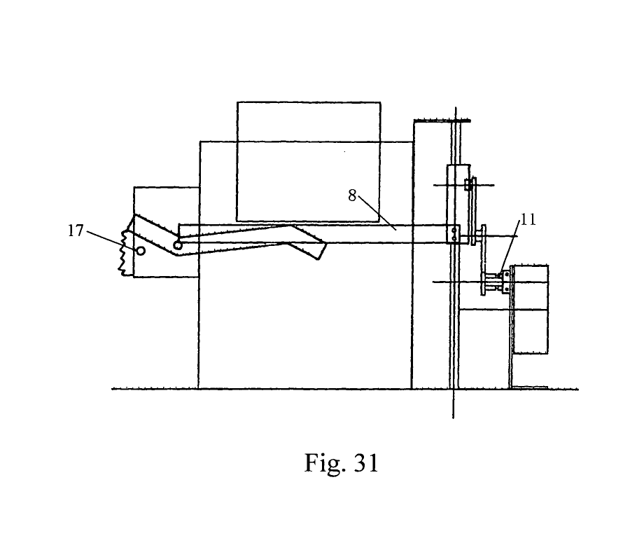

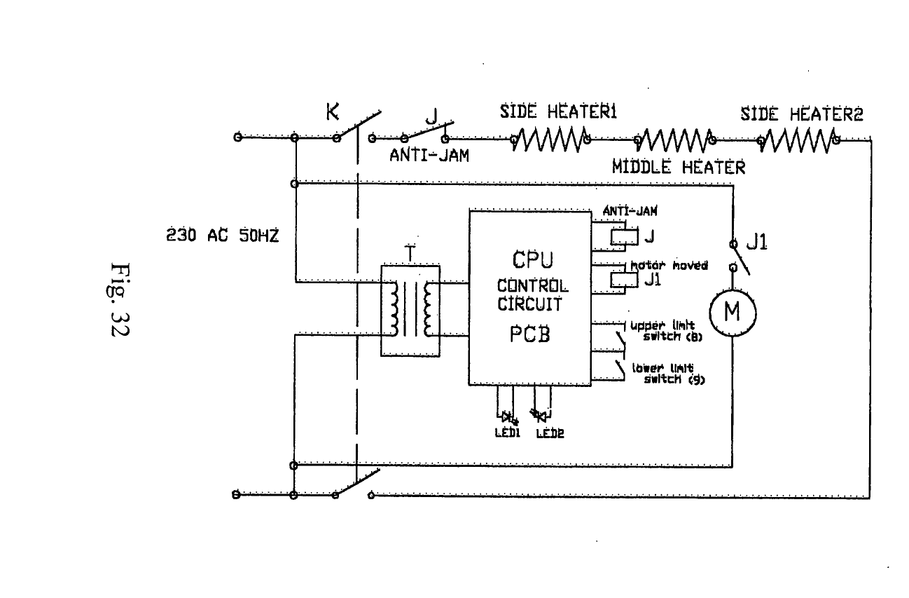

As shown in FIGS. 30 and 31, a joint portion between a toast rack 7 and a bracket 71 is hinged to a rear supporting board 21 of a toaster frame. An end of the bracket 71 is connected with the rear supporting board 21 of the toaster frame through a spring 16.

1. An actuating mechanism of an automatic toaster comprising:
a sliding rack being provided and being movable up and down within a housing of the toaster, which is fixed to a toast rack;
an assembly that is composed of a toast rack and a bracket, and hinged to the sliding rack, wherein an end of the toast rack is fixed to an end of the bracket;
a spring provided between an end portion of bracket and the sliding rack;
a sensor provided within the toaster to sense the angular displacement of the assembly;
a motor to drive the sliding rack to move up and down; and
a CPU electronically communicated with the sensor and the motor.

2. The actuating mechanism according to claim 1, wherein one end of the bracket is hinged to the sliding rack and the other end thereof is connected with the sliding rack through the spring.

3. The actuating mechanism according to claim 2, wherein a lower portion of the bracket is hinged to the sliding rack, and the spring is a tension spring.

4. The actuating mechanism according to claim 1, wherein a joint portion at which the toast rack is connected to the bracket is hinged to the sliding rack, and a free end of the bracket is connected with the sliding rack through the spring.

5. The actuating mechanism according to claim 1, wherein the sensor is fixed to a rear supporting board of a toaster frame.

6. The actuating mechanism according to claim 1, wherein the sensor is fixed to a front supporting board of the toaster frame.

7. The actuating mechanism according to claim 5, wherein an end of a fixed toast rack is connected to the sliding rack.

8. The actuating mechanism according to claim 7, wherein a joint portion at which the toast rack is connected to the bracket is hinged to the fixed toast rack, and the end portion of the bracket is connected with the sliding rack through the spring.

9. The actuating mechanism of an automatic toaster according to claim 7, wherein a joint portion at which the toast rack is connected to the bracket is hinged to the fixed toast rack, and the end portion of the bracket is connected with the fixed toast rack through the spring.

10. The actuating mechanism of an automatic toaster according to claim 7, wherein a joint portion at which the toast rack is connected to the bracket is hinged to a core bracket disposed on a bottom board of the toaster frame, the end portion of the bracket is connected with the core bracket through the spring, and the sensor is disposed to the bottom board.

11. The actuating mechanism of an automatic toaster according to claim 7, wherein a joint portion at which the toast rack is connected to the bracket is hinged to a rear supporting board of the toaster frame, and the end portion of the bracket is connected with the rear supporting board through the spring.

12. The actuating mechanism according to claim 7, wherein the sensor comprises an infrared light emitting diode and an infrared sensitive diode which are arranged opposite to each other.

13. The actuating mechanism according to claim 7, wherein the sensor comprises a pressure-controlled switch.

14. The actuating mechanism according to claim 7, wherein the sensor comprises a magnetic reed switch and a little piece of magnet which are arranged opposite to each other.
